(19) United States
(12) Patent Application Publication
(10) Pub. No.: US 2026/0092206 A1
(43) Pub. Date: Apr. 2, 2026

(54) RELEASE COATING COMPOSITIONS FOR ADHESIVE TAPE AND METHODS

(71) Applicant: Intertape Polymer Corp., Sarasota, FL (US)

(72) Inventors: John K. Tynan, Jr., Port Huron, MI (US); Austin Joseph Johnston, New Baltimore, MI (US); Louis Patrick Rector, Rochester Hills, MI (US)

(73) Assignee: Intertape Polymer Corp., Sarasota, FL (US)

(21) Appl. No.: 19/490,790

(22) PCT Filed: May 9, 2024
(86) PCT No.: PCT/US2024/028592

§ 371 Date: Dec. 5, 2025

Related U.S. Application Data
(60) Provisional application No. 63/466,127, filed on May 12, 2023.

(51) Int. Cl. C09J 7/40

(52) U.S. Cl. CPC C09J 7/401; C09J 2301/124; C09J 2425/005

(57) ABSTRACT

Described is a release composition comprising a polymer backbone with at least one C18-C22 alkyl (meth)acrylate monomer units, at least one C1-C6 alkyl (meth)acrylate methacrylate monomer units, and at least one styrenic monomer unit, and method of manufacture of the composition. Tape products incorporating the release composition as a release layer are also described.

### CROSS-REFERENCE TO RELATED APPLICATIONS

This application claims the benefit of U.S. Provisional Patent Application No. 63/466,127 filed on May 12, 2023, the entirety of which is incorporated herein by reference.

### TECHNICAL FIELD

This disclosure is directed to release coating compositions and release layers for adhesive tape and methods of manufacturing same.

### BACKGROUND

A pressure sensitive adhesive tape or sheet is generally wound in a roll form in which an adhesive layer is piled up on an adjacent back surface of a tape or sheet base material or is protected with a released sheet. The adhesive layer should have a good releasing property while in use so that the tape is easily released from the roll form with a relatively weak force. A known method to improve the property of a parting surface of the base material or the released sheet, the parting surface is treated with a silicone or fluorohydrocarbon based coating. Current environmental distain for silicone and fluorine-containing polymers that may wind up in the environment require different approaches and solutions.

Stearyl acrylate (SA)-based release compositions are also known. SA-based releasing compositions do provide blocking in the roll configuration, however, SA-based releasing compositions suffer from one or both of poor release and poor aging characteristics. Thus, while use of such SA releasing agents, e.g., having a long chain alkyl group, can overcome some of the above-described disadvantages of the known silicone/fluorohydrocarbon-based releasing agents, SA releasing agents still have undesirable aging properties, e.g., deterioration of the releasing property of the releasing agent itself, and poor adherence between the releasing agent and certain non-polar base material/backings.

### SUMMARY

In one example, a release composition is provided, comprising a polymer, the polymer comprising a backbone having a Structure (I):

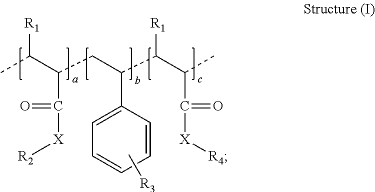

where R1, R2 and R3 are, independently, H, methyl, or a linear, branched, or cyclic alkyl of 2-6 carbons; where R4 is a linear, branched, or cyclic alkyl of 16-24 carbons;

where X is, independently, oxygen or NRa, where Ra is hydrogen, methyl, C2-C6 alkyl, aryl, or phenyl; where a, b, and c are monomer units; and each a, b, and c are >0; and where ----- denotes a covalent chemical bond between carbon atoms.

In one aspect, the a, b, and c are arranged in an alternating configuration, a random configuration, a block configuration, a graft configuration, or combinations thereof.

In one aspect, the Structure (I) is as follows:

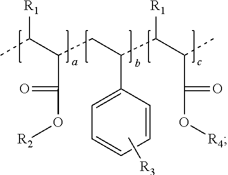

where R1, R2 and R3 are, independently, H, or methyl and where R4 is a linear, branched, or cyclic alkyl of 16-24 carbons.

In another example, a release composition is provided, comprising a polymer, the polymer comprising a backbone having a Structure (II):

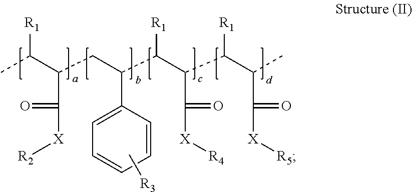

where R1, R2 and R3 are, independently, H, or methyl; wherein R4 and R5 are different and are, independently, a linear, branched, or cyclic alkyl of 16-24 carbons; where X is, independently, oxygen or NRa, where Ra is hydrogen, methyl, C2-C6 alkyl, aryl, or phenyl; where a, b, c and d are monomer units; and each a, b, c, and d are >0; and where ----- denotes a covalent chemical bond between carbon atoms.

In another example, a release composition is provided, comprising a polymer, the polymer comprising a backbone having a Structure (III):

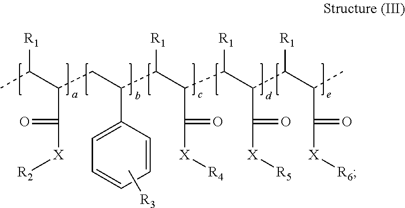

where R1, R2 and R3 are, independently, H, or methyl; where R4, R5, and R6 are, independently, a linear, branched, or cyclic alkyl of 16-24 carbons; where X is, independently, oxygen or NRa, where Ra is hydrogen, methyl, C2-C6 alkyl, aryl, or phenyl; where a, b, c, d, and e are monomer units; and each a, b, c, d, and e are >0; where - - - denotes a covalent chemical bond between carbon atoms; and wherein R4, R5, and R6 are different.

In one aspect, the R1 and R3 is hydrogen, R2 is methyl, and R4 is a C18 alkyl. In one aspect, alone or in combination with any one of the previous aspects, the R1 and R3 is hydrogen, R2 is methyl, and R4 is a linear C18 alkyl.

In one aspect, alone or in combination with any one of the previous aspects, the R1 and R3 is hydrogen, R2 is methyl, R4 is a C18 alkyl, and R5 is C20 alkyl. In one aspect, alone or in combination with any one of the previous aspects, the R1 and R3 is hydrogen, R2 is methyl, R4 is a linear C18 alkyl, and R5 is a linear C20 alkyl.

In one aspect, alone or in combination with any one of the previous aspects, the R1 and R3 is hydrogen, R2 is methyl, R4 is a C18 alkyl, R5 is C20 alkyl, and R6 is a C22 alkyl. In one aspect, alone or in combination with any one of the previous aspects, the R1 and R3 is hydrogen, R2 is methyl, R4 is a linear C18 alkyl, R5 is a linear C20 alkyl, and R6 is a linear C22 alkyl.

In one aspect, alone or in combination with any one of the previous aspects, the a>b. In one aspect, alone or in combination with any one of the previous aspects, the a>c. In one aspect, alone or in combination with any one of the previous aspects, the b>c. In one aspect, alone or in combination with any one of the previous aspects, the a>(b+c).

In one aspect, alone or in combination with any one of the previous aspects, the backbone further comprising monomer unit f of Structure (C):

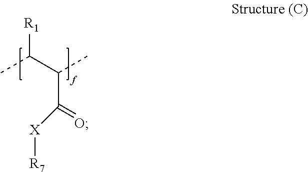

where f is a monomer unit >0; and where R7 is hydrogen, methyl, or a linear, branched, or cyclic alkyl of 2-6 carbons, with the proviso that R7≠R2.

In one aspect, alone or in combination with any one of the previous aspects, the R1, R3, and R7 is hydrogen, and R2 is methyl.

In another example, a rolled tape product is provided, the rolled tape product comprising: a backing having a first major surface and an opposing second major surface; an adhesive adjacent the second major surface; and a release layer between the adhesive layer and the first major surface, the release layer as defined in any one of the previous aspects.

In one aspect, the tape further comprises a second adhesive adjacent the first major surface, the release layer positioned between the second adhesive layer and the adhesive adjacent the second major surface. In one aspect, alone or in combination with any one of the previous aspects, the adhesive adjacent the second major surface and/or the second adhesive adjacent the first major surface, independently, is presented as a continuous or discontinuous layer.

In one aspect, alone or in combination with any one of the previous aspects, the backing comprises paper, plastic, ceramic, metal, or a combination thereof. In one aspect, alone or in combination with any one of the previous aspects, the backing comprises a reinforced non-polar film or sheet.

In one aspect, alone or in combination with any one of the previous aspects, the adhesive is a pressure sensitive adhesive (PSA).

In one aspect, alone or in combination with any one of the previous aspects, the tap has a high speed unwind as measured under PSTC-13 Method of about 9 oz/in (648 g/cm)+/−10%. In one aspect, alone or in combination with any one of the previous aspects, the release layer has an aged high speed unwind as measured under PSTC-13 Method of about 14 oz/in (1 kg/cm)+/−10%. In one aspect, alone or in combination with any one of the previous aspects, the release layer has a high speed adhesion to backing as measured under PSTC-4 Method of about 8 oz/in (576 g/cm)+/−10%.

In one aspect, alone or in combination with any one of the previous aspects, the release layer has an aged high speed adhesion to backing as measured by PSTC-4 of about 13 oz/in (936 g/cm). In one aspect, alone or in combination with any one of the previous aspects, the release layer is present on a backing as measured by ASTM F2217 in an amount of about 48 g/m2 to 58 g/m2 in a dry state. In one aspect, alone or in combination with any one of the previous aspects, the release layer has an adhesion to backing as measured by PSTC-101 B of about 18 oz/in (1.3 kg/cm).

In another example, a method of producing a release composition is provided, the method comprising: a) reacting at least one polymerizable monomer structure A(i), A(ii), and A(iii):

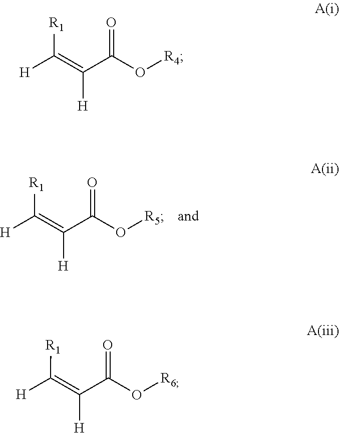

b) reacting at least one polymerizable monomer structure B(i):

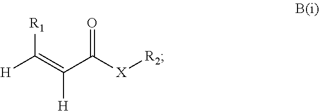

c) reacting at least one polymerizable styrenic monomer of structure B(ii):

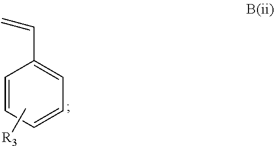

and
d) producing a release composition; where R1, R2 and R3 are, independently, H, methyl, or a linear, branched, or cyclic alkyl of 2-6 carbons; where X is, independently, oxygen or NRa, where Ra is hydrogen, methyl, C2-C6 alkyl, aryl, or phenyl; where R4 is a linear, branched, or cyclic alkyl of 18 carbons; where R5 is a linear, branched, or cyclic alkyl of 20 carbons; and where R6 is a linear, branched, or cyclic alkyl of 22 carbons.

In one aspect, the release composition produced comprise at least two polymerized monomers of the structure A(i), A(ii), and A(iii). In one aspect, alone or in combination with any one of the previous aspects, the release composition produced comprises polymerized monomers of the structure A(i), A(ii), and A(iii).

In one aspect, alone or in combination with any one of the previous aspects, a weight percent of B(i) is greater than a weight percent of any of the A(i), A(ii), and A(iii). In one aspect, alone or in combination with any one of the previous aspects, a weight percent of B(i) is greater than a weight percent of a sum of the A(i), A(ii), and A(iii). In one aspect, alone or in combination with any one of the previous aspects, a weight percent of B(i) is greater than a weight percent of a sum of the A(i), A(ii), A(iii) and B(ii). In one aspect, alone or in combination with any one of the previous aspects, a weight percent of B(ii) is greater than a weight percent of any of the A(i), A(ii), and A(iii).

In one aspect, alone or in combination with any one of the previous aspects, the method further comprises, before step d), reacting monomer C(i) in any one of steps a), b) or c), where the monomer C(i) has the following structure:

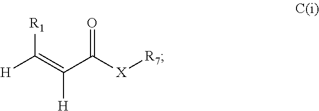

where R7 is hydrogen, methyl, or a linear, branched, or cyclic alkyl of 2-6 carbons, with the proviso that R7≠R2. In one aspect, X is oxygen, R1 and R7 are, independently, hydrogen or methyl.

In one aspect, alone or in combination with any one of the previous aspects, the steps a) and b) precedes step c). In one aspect, alone or in combination with any one of the previous aspects, the steps a) and step b) and step c) are performed essentially simultaneously.

### BRIEF DESCRIPTION OF THE DRAWINGS

In order to understand and to see how the present disclosure may be carried out in practice, examples will now be described, by way of non-limiting examples only, with reference to the accompanying drawings, in which:

FIG. 1A is a perspective view of a roll of tape for one embodiment of the disclosure;

FIG. 1B is an enlarged cross-sectional view of the tape of FIG. 1A, illustrating the layers thereof along line 3-3 of FIG. 1A;

FIG. 2A is a perspective view of a roll of tape for one embodiment of the disclosure;

FIG. 2B is an enlarged cross-sectional view of the tape of FIG. 2A, illustrating the layers thereof along line 4-4 of FIG. 2A.

### DETAILED DESCRIPTION

As used herein, “(meth)acrylate” and its plural is inclusive of free acid, salts, esters, and conjugate bases of acrylic acid and their mixtures in any proportion as well as free acid, salts, esters, and conjugate bases of methacrylic acid and their mixtures in any proportion.

“Alkyl-(meth)acrylate” as used herein, is inclusive of alkyl groups that can be linear, branched, cyclic, or combinations thereof in any proportion.

As used herein, “C1-C6 alky (meth)acrylate monomer” is inclusive of a polymerizable (meth)acrylate monomer having a linear, branched, or cyclic alkyl, for example, methyl acrylate, ethyl acrylate monomer, butyl acrylate monomer, isobutyl acrylate monomer, hexyl acrylate monomer, 1,1-dimethyl-butyl acrylate monomer, 1-methyl-pentyl acrylate monomer, 2-methyl-pentyl acrylate monomer, 3-methyl-pentyl acrylate monomer and 4-methyl-pentyl acrylate monomer, methyl methacrylate (MMA), ethyl methacrylate monomer, butyl methacrylate monomer, isobutyl methacrylate monomer, 1,1-dimethyl-butyl methacrylate monomer, 1-methyl-pentyl methacrylate monomer, 2-methyl-pentyl methacrylate monomer, and hexyl methacrylate monomer.

As used herein, “C16-C18 alkyl-(meth)acrylate monomer” is inclusive of a polymerizable (meth)acrylate monomer having a linear, branched, or cyclic alkyl (meth)acrylate with the linear, branched, or cyclic alkyl having 16, 17, or 18 total carbons, and mixtures thereof, for example, cetyl acrylate, stearyl acrylate, cetyl methacrylate, and stearyl methacrylate.

As used herein, “C20 alkyl-(meth)acrylate monomer” is inclusive of a polymerizable (meth)acrylate monomer having a linear, branched, or cyclic alkyl (meth)acrylate with the linear, branched, or cyclic alkyl having 20 total carbons, and mixtures thereof, for example, eicosyl (icosyl) acrylate, eicosyl (icosyl) methacrylate.

As used herein, “C22 alkyl-(meth)acrylate monomer” is inclusive of a polymerizable (meth)acrylate monomer having a linear, branched, or cyclic alkyl (meth)acrylate with the linear, branched, or cyclic alkyl having 22 total carbons, and mixtures thereof, for example, 1-docosanol (behenyl) acrylate monomer, 1-docosanol (behenyl) methacrylate monomer.

As used herein, “styrenic monomer” is inclusive of polymerizable vinyl-aromatic compounds having a single unsaturated site per molecule. Example of styrenic monomer include, for example, styrene, alkyl-substituted styrenes (e.g., alpha-methyl styrene, beta-methyl styrene alpha-ethyl styrene, and vinyl xylene), halogenated styrenes (e.g., chlorostyrene, bromostyrene and dichlorostyrene, with the exclusion of fluorostyrenes), other styrene derivatives having one or more nonreactive substituent groups on the benzene nucleus, as well as mixtures thereof.

The release composition of the present disclosure includes from about 20 wt. % to about 80 wt. %, 30 wt. % to about 70 wt. %, 40 wt. % to about 60 wt. % solids at least partially dispersed, distributed, dissolved or emulsified in an aqueous and/or non-aqueous medium. In one example, the solids of the release composition of the present disclosure is about 80 wt. % to about 100 wt. % and can be applied as a hot melt or syrup. The release composition of the present disclosure can be presented using a scrape blade, Meyer rod, reverse gravure, air spray, air knife and the like. In one example, the release composition of the present disclosure is applied at a thickness of about 0.04 mil to about 2.0 mil (about 1 micron to about 50 micron). In one example, the release composition of the present disclosure is applied at a thickness of about 0.1 mil to about 1.0 mil (about 2.5 micron to about 25.4 micron). In one example, application can be a film or coating of generally uniform thickness. In one example, application can be a random or structured pattern of the release composition of the present disclosure where the pattern presents the release composition with a spacing there between of greater than zero and less than 2 mil (50 micron).

The release composition, base material and/or adhesive can comprise additives such as fillers, processing stabilizers, weather resistance stabilizers, coloring agents, ultraviolet absorbing agents, light stabilizers, antioxidants, antistatic agents, flame-retardants, plasticizers, other impact modifiers, lubricants, perfumes, antifoaming agents, deodorants, bulking agents, releasing agents, mold releasing agents, reinforcing agents, crosslinking agents, fungicides, antiseptics, humectants, biocides, and crystallization rate retardants as necessary, in such a range that the effect of the present disclosure is not hindered.

The backing can be made from a wide variety of materials including organic polymers, reinforced polymers, thin metals, ceramic materials, fiberglass, etc. The backing can be a single layer or a composite of two or more layers of material. The composite can include metallized layers, barrier layers, nonwoven layers, polymer layers, paper layers, antistatic layers, primer layers, foam layers, and the like.

Pressure sensitive adhesives (PSA's) suitable for use with the presently disclosed release composition include, for example, coatable adhesives, such as solvent coatable, hot melt coatable, as well as latex PSA's that are coatable without of water and solventless curable adhesives can be used. Where thicker adhesive coatings are desired, it may be desirable either to apply multiple layers of the adhesive, hot melt coat, or to photopolymerize the adhesive in situ. Specific examples of pressure sensitive adhesives include acrylates, plasticizer-containing acrylates; natural or synthetic rubber resins, including thermoset rubbers as well as thermoplastic rubbers and elastomers, such as nitrile rubbers (e.g., acrylonitrile-butadiene), styrene-butadiene, styrene-isoprene, styrene-butadiene-styrene, styrene-isoprene-styrene, diblock A-B type and triblock A-B-A or A-B-C type block copolymers, and natural rubber; silicone-based adhesives, such as polysiloxanes; polyolefins; amorphous polyolefins (APO's), polyesters; polyamides; and polyurethanes.

In one example, the presently disclosed release composition is employed with adhesive tapes that are configured in the form of a roll. In one example, a back or backside of the tape (e.g., a single adhesive layer tape) is presented with the presently disclosed release composition.

In another example, the presently disclosed release composition is employed with a backing, such as a paper film that is coated on both sides so as to function as a dual-sided adhesive tape release liner in a dual-sided adhesive tape. Thus, in one example, a dual-sided roll of adhesive tape comprises a discrete release liner positioned between the adhesives that comprises the presently disclosed release composition.

The present disclosure provides materials of the kind referred to above (i e adhesive tapes and other self-sticking webs to be stored in the form of rolls having a release composition on a side of a base material or backing in contact with an adhesive, wherein the release composition comprises a blend of at least two materials.

In one example, presently disclosed release composition comprises the reaction product of a mixture of monomers, of which the reaction product is subsequently or concurrently reacted with a second mixture of monomers.

In one example, presently disclosed release composition comprises the reaction product of a mixture of alkyl (meth)acrylate monomers, of which the reaction product is subsequently or concurrently reacted with a mixture of at least one (meth)acrylate monomers and at least one styrenic monomer.

In one example, presently disclosed release composition comprises the reaction product of a mixture of alkyl (meth)acrylate monomers, of which a mixture of alkyl (meth)acrylate monomers is concurrently or subsequently reacted with at least one (meth)acrylate monomers and styrenic monomers.

In one example, the presently disclosed release composition comprises the reaction product of a composition comprising a mixture of C18-C22 alkyl acrylate monomers, of which the reaction product is subsequently or concurrently reacted with a composition of at least one methacrylate monomers and at least one styrenic monomer.

In one example, the mixture of alkyl-(meth)acrylate monomers comprises alkyl groups of at least 18 carbons. In one example, the combination of alkyl-(meth)acrylate monomers comprises alkyl groups of at least 20 carbons. In one example, the combination of alkyl-(meth)acrylate monomers comprise alkyl groups of at least 22 carbons. In one example, the combination of alkyl-(meth)acrylate monomers of Part A comprises alkyl groups of at least 18 carbons and at least 20 carbons. In one example, the combination of alkyl-(meth)acrylate monomers of Part A comprises alkyl groups of at least 18 carbons and at least 22 carbons. In one example, the combination of alkyl-(meth)acrylate monomers comprises alkyl groups of at least 20 carbons and at least 22 carbons.

In one example, the combination of alkyl-(meth)acrylate monomers comprises alkyl groups of 18 carbons, 20 carbons and 22 carbons in any proportion. In one example, the mixture of the C18:C20:C22 alkyl (meth)acrylate monomers comprises less than 2 weight percent (wt. %) of C16 alky (meth)acrylate monomer (including any less than C16 alky (meth)acrylate monomers) as intentionally added or as unintentionally present monomer. In one example, the mixture of the C18:C20:C22 alkyl (meth)acrylate monomers comprises less than 3 weight percent (wt. %) of C24 alky (meth)acrylate monomer (including any greater than C24 alky (meth)acrylate monomers) as intentionally added or as unintentionally present monomer.

In one example, the weight percent of the C18 alkyl (meth)acrylate monomers used is greater than the weight percent of C20 or C22 alkyl (meth)acrylate monomers. In one example, the weight percent of the 20 alkyl (meth)acrylate monomers used is between 3 and 20 weight percent. In one example, the weight percent of the C22 alkyl (meth)acrylate monomers used is between 35 to 50 weight percent.

In one example, the C18 alkyl-(meth)acrylate monomer is linear, branched, cyclic, or combinations. In one example, the C20 alkyl-(meth)acrylate monomer is linear, branched, cyclic, or combinations. In one example, the C22 alkyl-(meth)acrylate monomer is linear, branched, cyclic, or combinations.

In one example, the presently disclosed release composition comprises a reaction product of a least one (meth)acrylate monomers, styrenic monomers, optionally (meth) acrylic acid or acrylic acid monomer, and other monomers present at less than 1 wt. %, less than 0.1 wt. %, or less than 0.01 wt. %.

In one example, the presently disclosed release composition comprises a reaction product of at least one (meth)acrylate monomers and at least one styrenic monomer. In one example, the presently disclosed release composition comprises a reaction product of at least one (meth)acrylate monomers, styrenic monomers, and acrylic acid monomer. In one example, the presently disclosed release composition comprises a reaction product of a mixture of (meth)acrylate monomers, styrenic monomers, and (meth) acrylic acid monomer and other monomers present at less than 1 wt. %, less than 0.1 wt. %, or less than 0.01 wt. %.

In one example, the presently disclosed release composition comprises a reaction product of at least one of acrylic acid, C1-C6 alkyl-acrylate monomers and/or C1-C6 alkyl-methacrylate monomers and a styrenic monomer. In one example, C1-C6 alkyl-acrylate or methacrylate monomers comprise acrylate monomer, methyl acrylate monomer, ethyl acrylate monomer, propyl acrylate monomer, butyl acrylate monomer, isobutyl acrylate monomer, 1,1-dimethyl-butyl acrylate monomer, 1-methyl-pentyl acrylate monomer, 2-methyl-pentyl acrylate monomer, 3-methyl-pentyl acrylate monomer, 4-methyl-pentyl acrylate monomer, hexyl acrylate monomer, methacrylate monomer, methyl methacrylate monomer, ethyl methacrylate monomer, propyl methacrylate monomer, butyl methacrylate monomer, isobutyl methacrylate monomer, 1,1-dimethyl-butyl methacrylate monomer, pentyl methacrylate monomer, 1-methyl-pentyl methacrylate monomer, 2-methyl-pentyl methacrylate monomer, 3-methyl-pentyl methacrylate monomer, 4-methyl-pentyl methacrylate monomer, hexyl methacrylate monomer, and mixtures thereof. The alkyl of the C3-C6 alky (meth)acrylate monomer can be linear, branched, cyclic, or combinations.

In one example, the styrenic monomer of the presently disclosed release composition is styrene, alkyl-substituted styrene, e.g., alpha-methyl styrene, beta-methyl styrene alpha-ethyl styrene, and vinyl xylene, halogenated styrenes (e.g., chlorostyrene, bromostyrene and dichlorostyrene, with the exclusion of fluorostyrenes) and combinations thereof.

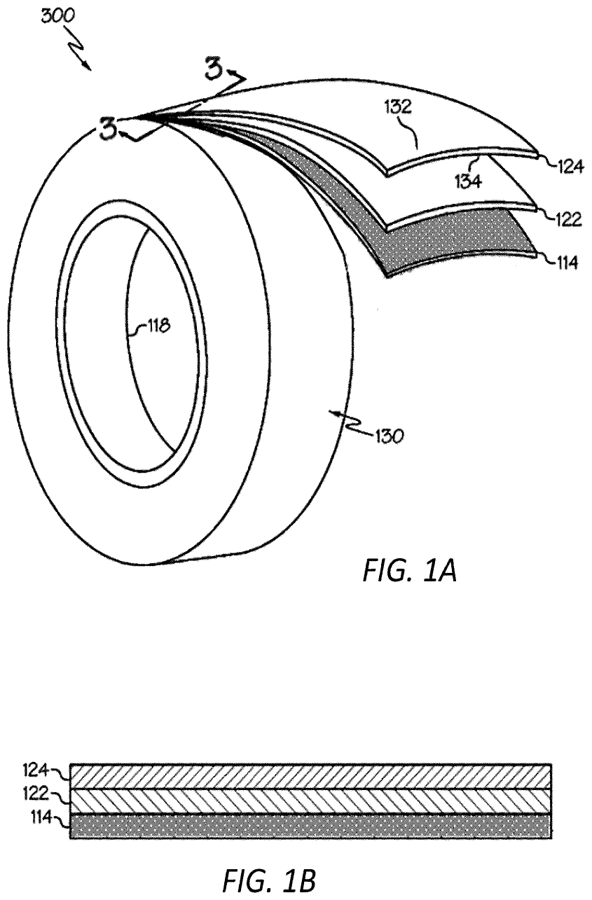

Turning now to the drawings, and referring initially to FIGS. 1A, 1B, a roll 300 of tape 130 wound onto a core 118 is shown, the role of tape having essentially a backing 124 an adhesive 122 and a release layer 114. Referring to FIGS. 1A and 1B for explanation, from top to bottom relative to the page, the tape 130 includes a backing 124, (also referred to as a substrate) has a first major (top) surface 132, a second major (bottom) surface 134, and a first side and a second side. As shown, an adhesive 122 is positioned adjacent to the backing 124 at second major surface 134, and a release layer 114 is positioned to the opposing surface of the adhesive 122.

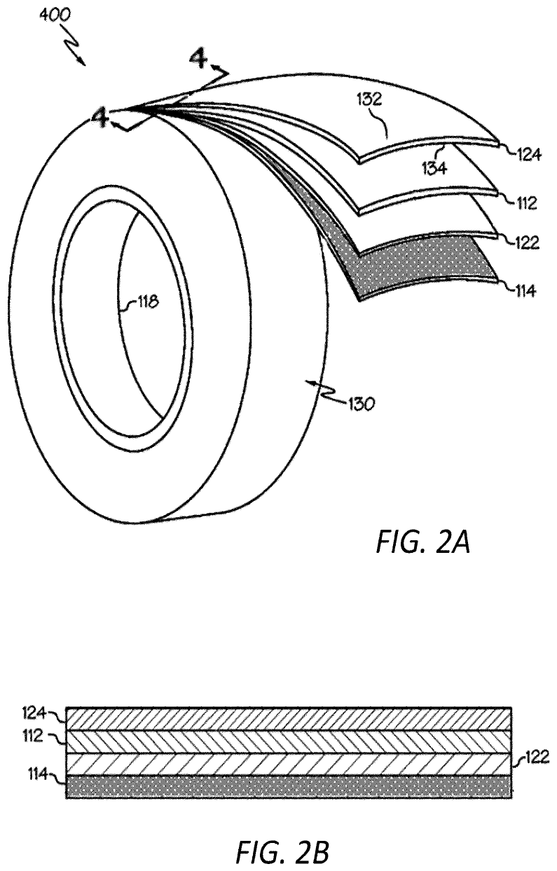

With reference to FIG. 2A, a roll 400 of tape 130 wound onto a core 118 the roll of tape having essentially a backing 124, an adhesive 122, a reinforcement layer 112 and a release layer 114. Referring to FIGS. 2A and 2B for explanation, from top to bottom relative to the page, the tape 130 includes a paper backing 124. The backing 124 (also referred to as a substrate) has a first major (top) surface 132, a second major (bottom) surface 134, and a first side and a second side. As shown, an adhesive is positioned adjacent to the backing 124 at second major surface 134. As shown in FIGS. 2A, 2B, an additional (reinforcement) layer 112 is positioned adjacent second major surface 134 of backing 124. Adhesive 122 is applied to an opposing surface of the additional layer 112, and a release layer 114 is positioned to the opposing surface of the adhesive 122.

In one example, the backing 124 and adhesive are extrusion laminated. In one example, the backing 124 and adhesive 122 are extrusion laminated without an additional material, e.g., one surface of the adhesive is activated, and laminated directly to the backing 124. In another example, the backing 124 and adhesive are extrusion laminated together with a softened or molten layer there between that laminates the layers together, which once set, solidifies. The softened or molten layer can be extruded between the backing 124 and adhesive 122 or coextruded with the adhesive.

In one example, the backing 124 and adhesive are adhesive laminated. In one example, the backing 124 and adhesive are adhesive laminated without an adhesive, e.g., one surface of the adhesive is activated, e.g., with a state of water and adhered directly to the paper backing 124. In another example, the backing 124 and adhesive are adhesive laminated together with a layer or discontinuous pattern of adhesive there between that adheres the layers together. The adhesive can be extruded between the backing 124 and adhesive 122 or coextruded with the adhesive.

With reference to roll 300,400, in one example, the adhesive 122 and release layer 114 are extrusion laminated. In one example, the adhesive 122 and release layer 114 are extrusion laminated without an additional material, e.g., one surface of the release layer 114 is laminated directly to the adhesive 122.

With reference to roll 400, in one example, the backing 124, additional (reinforcement) layer 112, and adhesive 122 are extrusion laminated. In one example, the backing 124, additional (reinforcement) layer 112, and adhesive 122 are extrusion laminated without an additional material and laminated directly to the backing 124. As shown, roll 400 further comprises release layer 114 adjacent the opposing side of the adhesive 122.

The aforementioned processing steps for rolls 300, or 400 can be carried out continuously, semi-continuously, or in batches.

Optionally, included in the paper backing 124 is an additional release material that can bloom to the major surface 132. In one example, the roll 300, 400 is without an additional release material in the backing. With regard to the structures, for example, Structure (I): it is understood that the following structures are understood to be equivalent, where hydrogen bound to a carbon atom is not shown:

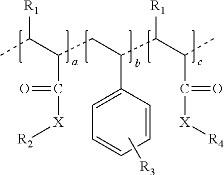

is the equivalent of

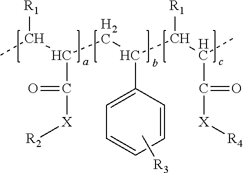

### EXAMPLES

Toluene was charged to a reactor followed by pre-melted stearyl acrylate (e.g., SA 18 sold by BASF Group) and a commercial blend of C18-C22 acrylates with trace amounts of C16 and C24 acrylates (e.g., BEA 1822 sold by BASF Group) with stirring and nitrogen purge was added. The reactor is heated to 70° C., with continuous mixing. When reactor contents equilibrated at 70° C., free radical initiator was added. In one example, azobisisobutyronitrile (AIBN) was used, however, other initiators can be used. The initiator can be added as a solid or dissolved in the solvent used.

After the exotherm (˜4-7° C.), the reactor contents were cooled by half of the amount of exotherm and introduction of the C1-C6 alkyl-(meth)acrylate monomers and styrenic monomers (e.g., methyl methacrylate and styrene) with additional initiator was carried out over a period of about 1 hour. After the C1-C6 alkyl-(meth)acrylate monomers and styrenic monomers solution addition is complete, the reactor contents were held at about 66-72° C. for about 20 hours. Thus, in one example, the copolymer prepared from the C18-C22 alkyl-(meth)acrylate monomers was present during the polymerization of the monomers of C1-C6 alkyl-(meth)acrylate monomers and styrenic monomers.

The manufactured release coating was roll coated onto a crepe paper backing material having a natural rubber PSA and subjected to standard testing with the following results:

TABLE 1
Performance Testing of Presently Disclosed Release Composition

| Test | Testing Method | Typical Values |
|---|---|---|
| High Speed Unwind (HSUW) | PSTC-13 (2014) | 9 oz/in +/− 10% |
| Aged High Speed Unwind 50° | PSTC-13 (2014) | 14 oz/in +/− 10% |
| C./50% RH for 7 days (HSUW) | | |
| High Speed Adhesion to | PSTC-4 (2014) | 7.9 oz/in +/− 10% |
| Backing (HSAB) | | |
| Aged High Speed Adhesion to | PSTC-4 (2014) | 12.6 oz/in +/− |
| Backing 50° C./50% RH for 2 | | 10% |
| days (HSAB) | | |
| Adhesive Coat weights in grams | ASTM F2217 | 52.1 + 3.3 |
| per square meter | (2014) | gsm +/− 10% |
| Release coat detackification of | Proprietary | 0% |
| the tape's adhesive | method | |
| Adhesion to backing | PSTC-101 B | 17.6 oz/in +/− 10% |
| | (2014) | |
| Molecular Weight (Mn) | GPC | 20,000 to 50,000 |
| Molecular Weight (Mw) | GPC | 30,000 to 75,000 |

While certain embodiments of the present disclosure have been illustrated with reference to specific combinations of elements, various other combinations may also be provided without departing from the teachings of the present disclosure. Thus, the present disclosure should not be construed as being limited to the particular exemplary embodiments described herein and illustrated in the Figures but may also encompass combinations of elements of the various illustrated embodiments and aspects thereof.

1-42. (canceled)

43. A release composition comprising a polymer, the polymer comprising a backbone having a Structure (I): 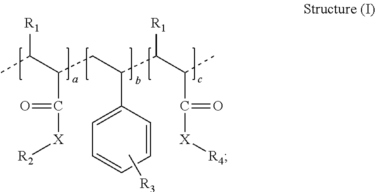
where R1, R2 and R3 are, independently, H, methyl, or a linear, branched, or cyclic alkyl of 2-6 carbons;
where R4 is a linear, branched, or cyclic alkyl of 16-24 carbons;
where X is, independently, oxygen or NRa, where Ra is hydrogen, methyl, C2-C6 alkyl, aryl, or phenyl;
where a, b, and c are monomer units; and each a, b, and c are >0; and
where ----- denotes a covalent chemical bond between carbon atoms.

44. The release composition of claim 43, wherein: a>b, or wherein a>c or wherein b>c or wherein a>(b+c).

45. The release composition of 43, wherein Structure (I) is as follows: 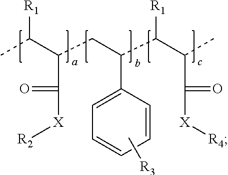
where R1, R2 and R3 are, independently, H, or methyl and where R4 is a linear, branched, or cyclic alkyl of 16-24 carbons.

46. The release composition of claim 45, wherein R1 and R3 is hydrogen, R2 is methyl, and R4 is a C18 alkyl.

47. The release composition of claim 45, wherein R1 and R3 is hydrogen, R2 is methyl, and R4 is a linear C18 alkyl.

48. A release composition comprising a polymer, the polymer comprising a backbone having a Structure (II): 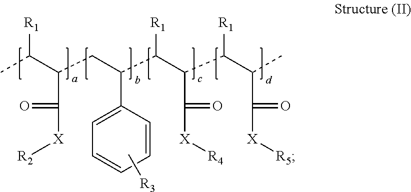
where R1, R2 and R3 are, independently, H, or methyl;
wherein R4 and R5 are different and are, independently, a linear, branched, or cyclic alkyl of 16-24 carbons;
where X is, independently, oxygen or NRa, where Ra is hydrogen, methyl, C2-C6 alkyl, aryl, or phenyl;
where a, b, c and d are monomer units; and each a, b, c, and d are >0;
where ----- denotes a covalent chemical bond between carbon atoms.

49. The release composition of claim 48, wherein R1 and R3 is hydrogen, R2 is methyl, R4 is a C18 alkyl, and R5 is C20 alkyl.

50. The release composition of claim 48, wherein R1 and R3 is hydrogen, R2 is methyl, R4 is a linear C18 alkyl, and R5 is a linear C20 alkyl.

51. The release composition of claim 48, wherein a, b, c, d, and e are arranged in an alternating configuration, a random configuration, a block configuration, a graft configuration, or combinations thereof.

52. The release composition of claim 48, wherein: a>b, or wherein a>c or wherein b>c or wherein a>(b+c).

53. A release composition comprising a polymer, the polymer comprising a backbone having a Structure (III): 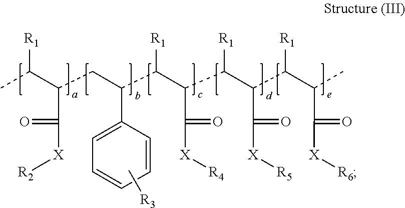
where R1, R2 and R3 are, independently, H, or methyl;
where R4, R5, and R6 are, independently, a linear, branched, or cyclic alkyl of 16-24 carbons;
where X is, independently, oxygen or NRa, where Ra is hydrogen, methyl, C2-C6 alkyl, aryl, or phenyl;
where a, b, c, d, and e are monomer units; and each a, b, c, d, and e are >0;
where ----- denotes a covalent chemical bond between carbon atoms; and
wherein R4, R5, and R6 are different.

54. The release composition of claim 53, wherein R1 and R3 is hydrogen, R2 is methyl, R4 is a C18 alkyl, R5 is C20 alkyl, and R6 is a C22 alkyl.

55. The release composition of claim 53, wherein R1 and R3 is hydrogen, R2 is methyl, R4 is a linear C18 alkyl, R5 is a linear C20 alkyl, and R6 is a linear C22 alkyl.

56. The release composition of claim 53, wherein a, b, c, d, and e are arranged in an alternating configuration, a random configuration, a block configuration, a graft configuration, or combinations thereof.

57. The release composition of claim 53, wherein: a>b, or wherein a>c or wherein b>c or wherein a>(b+c).

58. The release composition of claim 53, wherein the backbone further comprising monomer unit f of Structure (C): 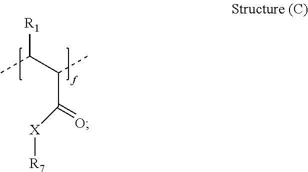
where f is a monomer unit >0; and where R7 is hydrogen, methyl, or a linear, branched, or cyclic alkyl of 2-6 carbons, with the proviso that R7≠R2.

59. A method of producing a release composition comprising:
a) reacting at least one polymerizable monomer structure A(i), A(ii), and A(iii): 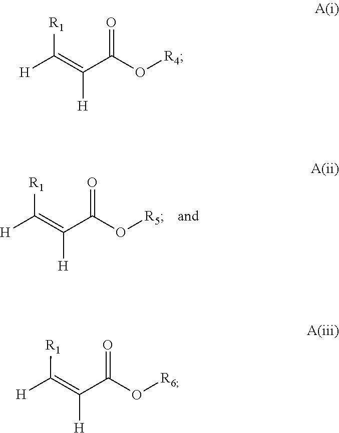
b) reacting at least one polymerizable monomer structure B(i): 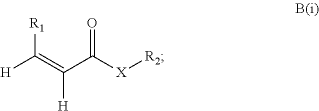
c) reacting at least one polymerizable styrenic monomer of structure B(ii): 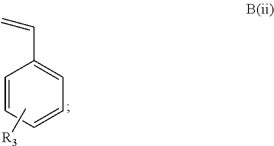
and
d) producing a release composition;
where R1, R2 and R3 are, independently, H, methyl, or a linear, branched, or cyclic alkyl of 2-6 carbons;
where X is, independently, oxygen or NRa, where Ra is hydrogen, methyl, C2-C6 alkyl, aryl, or phenyl;
where R4 is a linear, branched, or cyclic alkyl of 18 carbons;
where R5 is a linear, branched, or cyclic alkyl of 20 carbons; and
where R6 is a linear, branched, or cyclic alkyl of 22 carbons.

60. The method of claim 59, further comprising, before step d), reacting monomer C(i) in any one of steps a), b) or c), where the monomer C(i) has the following structure: 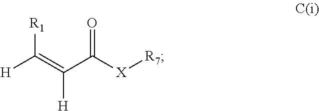
where R7 is hydrogen, methyl, or a linear, branched, or cyclic alkyl of 2-6 carbons, with the proviso that R7≠R2.

61. A rolled tape product comprising:
a backing having a first major surface and an opposing second major surface;
an adhesive adjacent the second major surface; and
a release layer between the adhesive layer and the first major surface, the release layer as defined in claim 53.

62. The rolled tape product of claim 61, further comprising a second adhesive adjacent the first major surface, the release layer positioned between the second adhesive layer and the adhesive adjacent the second major surface.
